(19) United States
(12) Patent Application Publication
(10) Pub. No.: US 2021/0334811 A1
(43) Pub. Date: Oct. 28, 2021

(54) System and Method for Fraudulent Scheme Detection using Time-Evolving Graphs

(71) Applicant: PAYPAL, INC., San Jose, CA (US)

(72) Inventors: Jun Gu, Shanghai (CN); Ni Bei, Shanghai (CN); Jie Huang, Shanghai (CN); Gaoyuan Wang, San Jose, CA (US)

(21) Appl. No.: 16/339,642

(22) PCT Filed: Dec. 21, 2018
(86) PCT No.: PCT/CN2018/122662

§ 371 Date: Apr. 4, 2019

(51) Int. Cl. G06Q 20/40; G06F 16/901

(52) U.S. Cl. CPC G06Q 20/4016; G06F 16/9024

(57) ABSTRACT

Aspects of the present disclosure involve systems, methods, devices, and the like for fraudulent scheme detection. In one embodiment, a time-evolving graph-based solution is presented for the Ponzi scheme detection. For the solution, unbounded and time-based relational data is transformed to the time-evolving graph structure. Time-based aggregate metrics are computed and captured based in part on changes occurring within user accounts and transactions identified within the time-evolving graph structure. Then, with the aid of know pattern flows and the application of filtering rules, detection of such a fraudulent scheme may be accomplished.

### TECHNICAL FIELD

The present disclosure generally relates to fraudulent scheme detection using communication devices, and more specifically, to fraudulent scheme detection using time-evolving graphs on communication devices.

### BACKGROUND

Nowadays with the evolution and proliferation of electronics, digital transactions are becoming a common place. In some instances, the transactions may be driven by a common actor or organization where current members of the organization are compensated based in part on an action taken by a new member of the organization. For example, consider current member compensation, the current members will receive a payment or return using capital obtain from a new investor to the organization. Thus, the organization does not use profit earn for paying the current member and a misperception is introduced where current members are led to believe that sale of a product produced a profit which enabled the compensation payment. Such payment and type of investment may lead to high rates of return however, such investment is also often susceptible to quick collapse as recruiting new members or investors comes difficult.

This type of investment scheme can affect not only the members of the organization, but also have an effect the payment providers through loss of monetary funds. Therefore, payment providers often perform manual research to identify risky accounts, calculate statistical metrics, and/or take static snapshots of metrics regarding potential accounts. However, the use of such detection mechanisms may be slow, lack identification processes, and are not in real-time. Thus, it would be beneficial to create a system that can detect these types of schemes.

### BRIEF DESCRIPTION OF THE FIGURES

FIG. 1 illustrates a tree structure applicable to Ponzi scheme.

FIG. 2 illustrate block diagrams of an exemplary system and time-evolving graph for detecting a Ponzi scheme.

FIGS. 3A-3C illustrate exemplary graphs of varying flow patterns associated with a Ponzi scheme.

FIG. 4 illustrates an exemplary subgraph extraction from a graph of a flow pattern for associated with a Ponzi scheme.

FIG. 5 illustrates an exemplary time-evolving graph for Ponzi scheme detection.

FIG. 6 illustrates a flow diagram illustrating operations for Ponzi scheme detection using time-evolving graphs.

FIG. 7 illustrates an example block diagram of a computer system suitable for implementing one or more devices of the communication systems of FIGS. 1-6.

Embodiments of the present disclosure and their advantages are best understood by referring to the detailed description that follows. It should be appreciated that like reference numerals are used to identify like elements illustrated in one or more of the figures, whereas showings therein are for purposes of illustrating embodiments of the present disclosure and not for purposes of limiting the same.

### DETAILED DESCRIPTION

In the following description, specific details are set forth describing some embodiments consistent with the present disclosure. It will be apparent, however, to one skilled in the art that some embodiments may be practiced without some or all of these specific details. The specific embodiments disclosed herein are meant to be illustrative but not limiting. One skilled in the art may realize other elements that, although not specifically described here, are within the scope and the spirit of this disclosure. In addition, to avoid unnecessary repetition, one or more features shown and described in association with one embodiment may be incorporated into other embodiments unless specifically described otherwise or if the one or more features would make an embodiment non-functional.

Aspects of the present disclosure involve systems, methods, devices, and the like for fraudulent scheme detection. In one embodiment, a time-evolving graph-based solution is presented for the Ponzi scheme detection. For the solution, unbounded and time-based relational data is transformed to the time-evolving graph structure. Time-based aggregate metrics are computed and captured based in part on changes occurring within user accounts and transactions identified within the time-evolving graph structure. Then, with the aid of know pattern flows and the application of filtering rules, detection of such a fraudulent scheme may be accomplished.

Ponzi schemes are investment techniques often used to lure members to invest in an organization and then use the funds invested to pay current members. The scheme may be considered a fraudulent operation where a member may be led to believe that a product or service sold by the organization generated the profit to pay the current member, where in reality, the member is paid using the newly invested funds obtained from a new member or investor. Although such investment scheme offers high rates of returns, such schemes tend to collapse when it becomes difficult to recruit new members or when a large number of members ask to cash out.

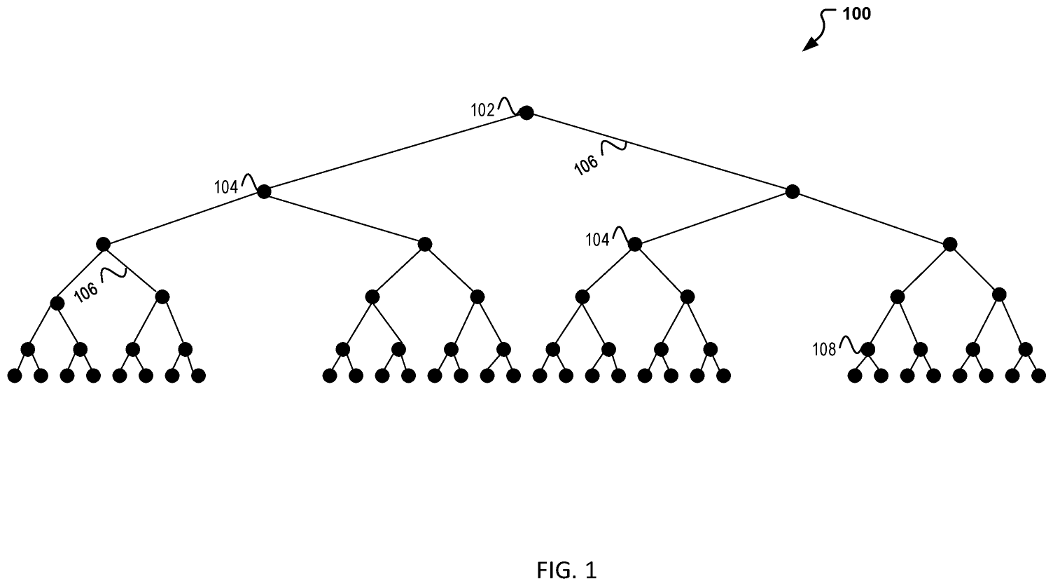

To illustrate this, consider FIG. 1. At FIG. 1, a tree structure 100 illustrating a traditional Ponzi scheme is presented. Notice that tree structure 100 illustrates the mapping of relationships between the members of the organization. Generally, tree structures 100 can be described in terms of nodes and branches. The root node 102 can be the starting point of the tree as illustrated in FIG. 1. Root node 102, can be the top most node which indicates the start of the tree structure 100 and in the Ponzi scheme can be used to denote the main investor or top executive of the organization. Extending from the root node 102 off branches 106 are other nodes 104 indicating other members or investors to the organization. As illustrated, from each of the investors (e.g., nodes 104), new investors (nodes 106) are then included. Thus, in the Ponzi scheme, investment funds obtained when new investors (nodes 106) are used to pay the investors (nodes 104) instead of paying using any profit the organization may have. Therefore, with tree structure 100, it can easily be seen that the structure can easily collapse if new members (nodes 106) are not recruited and/or a large number of the investors (nodes 104) cash out.

Such collapse in this scheme can be problematic not only for investors and the organization, but also for the payment provider. The payment provider's reputation and goodwill may be hurt, and monetary funds may be lost as a result of a collapse in such scheme. Therefore, it is beneficial to identify and use strategies that will aid in the identification of such schemes. Traditionally, payment providers and other involved parties, entities or investigators have performed such identification manually where risky accounts are flagged. Additionally, statistical methods have been used for such identification. However, these statistical methods often target a single account or are static in time.

In one embodiment, a system and method are introduced that aid in the identification of such types of schemes through the generation of a technique that not only evolves based on changes in the account, but also maintains a time-based metric which can be used to capture trends and detect potential Ponzi scheme accounts.

Generally, this type of solution entails the generation of time-based flow graphs constructed from transactions occurring between one or more users and/or accounts over a given time period. Then, with the understanding that Ponzi schemes have a flow pattern, extracting from the time-based flow graphs, subgraphs which are characterized as those corresponding to a Ponzi scheme and finalizing with the definition of time-based metrics which can be analyzed to identify if a Ponzi scheme is occurring.

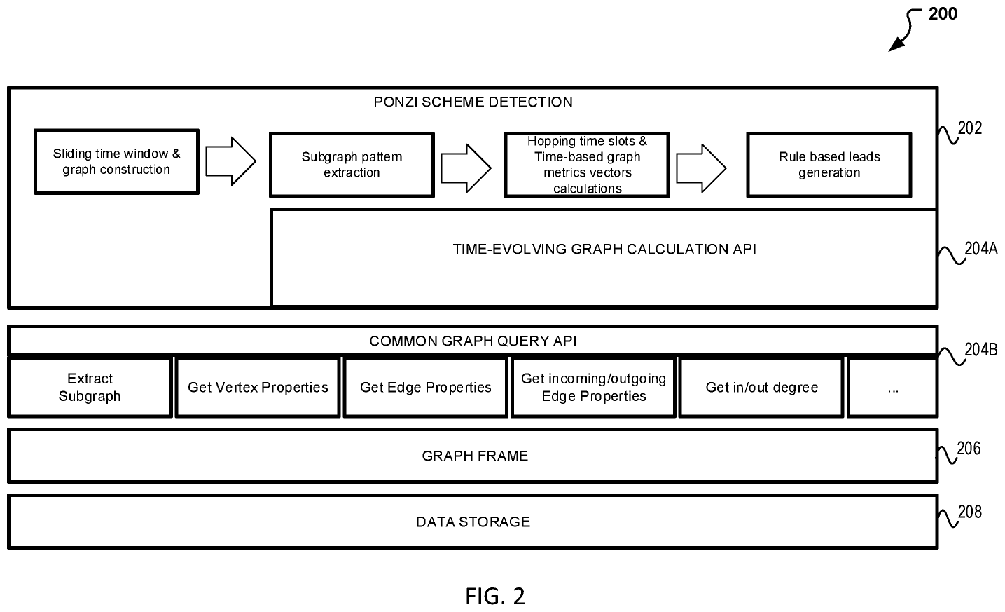

Turning to FIG. 2, an exemplary system architecture 200 is illustrated for detecting a Ponzi scheme. As illustrated, for this system architecture 200 and implementation of Ponzi scheme detection, a multi-layer system is used. In one embodiment, the implementation of a Ponzi scheme detection solution using a time-based metric, application layer 202, graph API layer 204, graph computation layer 206, and storage layer 208 are used. In particular, at the application layer, the Ponzi scheme detection algorithm is implemented, and metrics calculated. For example, at FIG. 2, an application layer 202 is illustrated where the Ponzi scheme detection algorithm includes the generation of a sliding time window and graph construction. Then, upon the construction of a graph or time-based flow graph, extract subgraphs based on the identification of a pattern associated with a Ponzi scheme. The process of graph construction and subgraph extraction is then repeated over a hopping time slot and from which time-based metrics can be computed. Finally, as the metrics are observed, rule-based leads may be generated and used for the identification process.

Next, because the method involved in detecting a Ponzi scheme includes the generation of a time-evolving graph, a graph application program interface (API) layer is used and present in the system architecture 200 of FIG. 2. Generally, an API can be a set of instructions, protocols, routines, etc. which can be implemented and designed to communicate and create an application which can interact with a system's operating system. Therefore, as illustrated at system architecture 200 a graph API layer 204 is included with a time-evolving graph calculation API 204A which can get different types of time-based graph metric vectors for use in the rule-based lead generation and detection. Further to the time-evolving graph calculation API 204A, the graph API layer 204 can also include a common graph query API 204B. At the common graph query API 204B attributes associated with the graphs may be collected and subgraphs extracted. For example, as illustrated on the system architecture 200, the graph API Layer 204 and in particular in the common graph query API 204b, vertex properties, edge properties, graph degree (based on in-coming/out-going transactions), and edge properties may be collected, and subgraph extracted.

Further to the Graph API layer, the time-evolving graph generating, Ponzi scheme detection system architecture 200 can also include a graph computation layer 206. The graph computation layer 206, is a layer in the system architecture 200 that can be used for the generation of the graph, based on data extracted from transactions. For example, at the graph computation layer 206, graph vertices can be used to represent users and edges represent relationships between users. Alternatively, the graph computation layer can create a graph where the edges represent a transaction, and the vertices represent accounts. To generate such graphs, propriety and/or open sources programs may be used (e.g., GraphFrame). In one embodiment, an open source program can be used to provide DataFrame based APIs which may be used in the implementation and graph implementation. For example, an open source general-purpose cluster computing framework may be used for data retrieval and use a dataset and interface for the organization and creation of the graphs. The data retrieval may be achieved through the use of a storage layer 208. The storage layer 208 can include the storage of the data including the transactions, accounts, and users associated with the time-evolving graphs to be generated for this Ponzi scheme detection solution.

Note that system architecture 200 is presented for exemplary purposes and one or more layers may be added and/or removed. Additionally, the storage layer 208 and graph computation layer 206 are not limited to the use of a data storage or dataset, alternative solutions may be used including but not limited to GraphFrame, Hive, Teradata, Neo4j, OrientDB. Further, additional graph-based APIs can be added to the graph API layer 204. Still further, the architecture system can be extended for other fraud detection schemes such as but not limited to the pyramid scheme, MLM, etc.

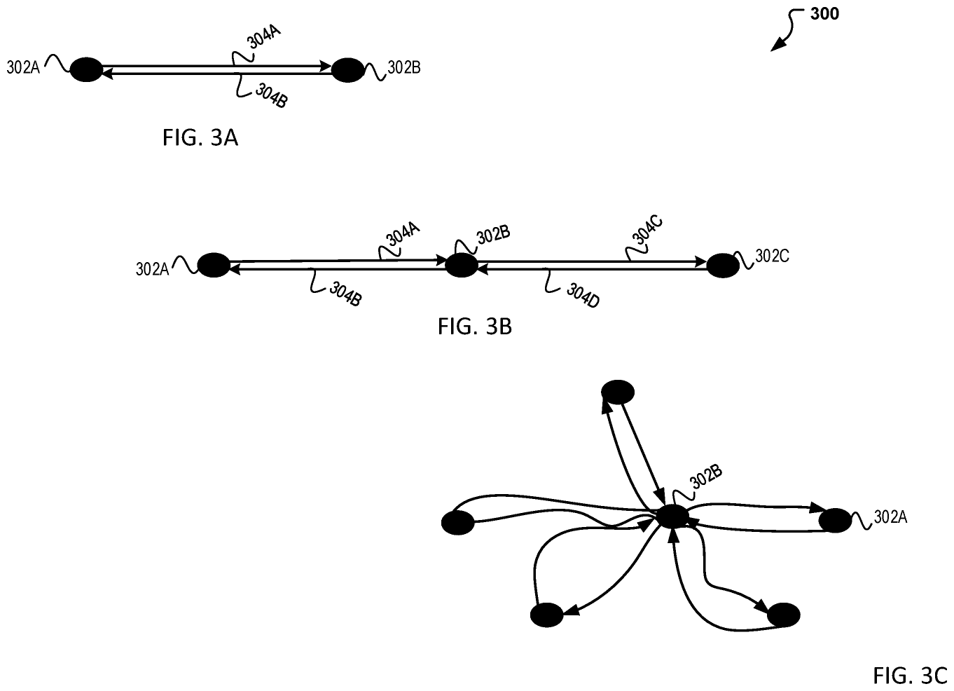

In an effort to define Ponzi scheme detection in more detail, the graph generation, subgraph extraction, metric determination, and detection are described below and in conjunction with FIGS. 3A-5. For example, turning to FIGS. 3A-3C exemplary graphs of varying flow patterns associated with or customary to a Ponzi scheme are illustrated. In particular, consider a user account, an account with a merchant, transactions between users, etc., wherein payment data is often unbounded and time-evolving. In one embodiment, the data is transformed into a time-evolving graph structure built using a series of nodes (vertexes) and branches (edges). For example, in one representation, consider FIG. 3A wherein a vertex 302 may be used to represent an account. Therefore, at FIG. 3A, the graph may be used to represent a transaction 304 between two accounts 302A,302B. Additionally, or alternatively, the vertexes may be used to represent a uniform resource locator (URL), business name, user name, identification number, etc. and branches can designate transaction amount, timestamp, etc. Thus, FIG. 2A can represent a request and response between two accounts 302A, 302B. Alternatively, FIG. 2A can represent a transaction between two businesses 302A, 302B. Still as another alternative, FIG. 2A, can represent a communication between a first URL and a second URL at a given time. In one embodiment, FIG. 2A can illustrate a transaction between two accounts, wherein at the vertex 302, in addition to the account information, other relevant information including but not limited to account number, business name, URL, etc. may be stored. Similarly, the edge 304 can represent a payment sent from between accounts 302 and attributes within the edge can further include relevant information including but not limited transaction information, amount, time stamp, etc.

Using the same criteria, the relationship between more users, business, individuals, accounts etc. can be graphed as was the first account relationship. Therefore, turning to FIG. 3B, an exemplary flow is illustrated where a relationship, communication, transaction, time, etc. can be mapped between more than two contributors transacting. As exemplified, the communication now entails accounts 302A-302C transacting with in each as illustrated by the edges 304 on the graph. Extending a similar approach to transactional data and payments sent over time, the relational data can be transformed into a graph similar to the one illustrated in FIG. 3C. As illustrated in FIG. 3C, the transactions between various accounts is illustrated using the vertexes and edges presented. As such, the transactional data have been transformed into a graph such structure and data may have been considered unbounded and time-based, has now become a time-based payment graph that evolves over time.

Note that based on the graphs described above and in conjunction with FIGS. 3A-3C, a pattern flow can be established. For example, at FIG. 3A a payment sent and received between two accounts, a [vertex A (302A)->edge (304A)->vertex B (302B) && vertex B (302B)->edge (304B)->vertex A(302A)]. As another example, at FIG. 3B a transaction between three accounts is established such that a multi-layer graph is generated where a pattern flow can then again be created such as but not limited to [vertex A (302A)->edge (304A)->vertex B (302B) && vertex B (302B)->edge (304B)->vertex A(302A)&& vertex B (302B)->edge (304C)->vertex C (302C) && vertex C (302C)->edge (304D)->vertex B (302B)]. Using such representation scheme, transactions that are part of a Ponzi scheme may be identified. For example, after some analysis of such transactions it may be determined that transactions involved in a Ponzi scheme, generally have specific pattern flows. These patterns can then be recognized and used in detecting those accounts which may be involved in such scheme.

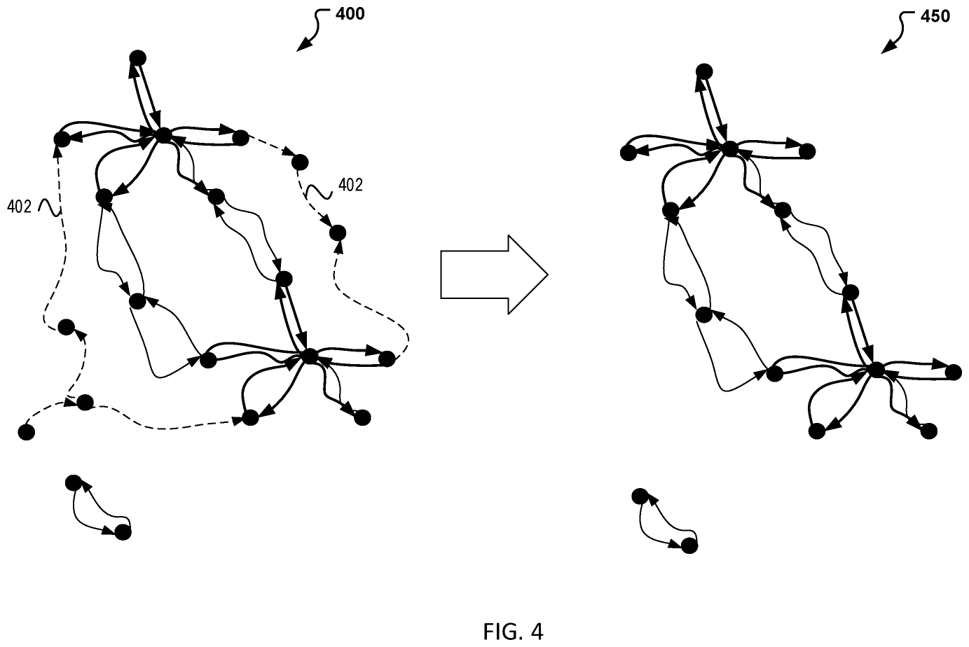

Turning to FIG. 4, a graph has been generated to illustrate the graph generated from associations between accounts as transactions occur. In consideration of the pattern flow associated with a Ponzi scheme, detection can then be measured. For example, assume that a Ponzi scheme includes transactions wherein a 2-way communication occurs between two accounts. As such, graph 400 is presented illustrating the overall account associations or transactions. Notice that graph 400 illustrates the direction of the association or direction of the transaction with the use of arrows. Therefore, while taking into consideration the flow patterns that distinguish a Ponzi scheme, transactions that do not follow the flow patterns may be distinguished by edges 402. Thus, FIG. 4B illustrates an exemplary subgraph 450 extraction from graph 400 based on the flow patterns associated with a Ponzi scheme. Because Ponzi schemes have high returns, these accounts generally have both a payment sent and received. To recognize the patterns on the graph 400, the subgraph 450 is retrieved with those accounts that have at least one payment sent, and one payment received within a sliding time window. The sliding window can be a defined period of time which can be used to define the time for which these time-evolving graphs will be created. The subset of accounts and payments that occur during the sliding time window are graphed and accounted for. And in particular for those accounts whose graph shows a vertex A with an edge to a vertex B and then back to vertex A as previously described. Note that for simplicity, this type of relationship, the vertex A and B are considered followers of each other. Referring to FIG. 4A, the vertexes/edges that do not exhibit this bidirectional relationship are distinguished by the dashed line 402 and removed from subgraph at FIG. 4B. Therefore, subgraph 450 is extracted from graph 400 where only those transactions with followers are illustrated.

Note that although a Ponzi scheme subgraph is illustrated here, other relational schemes may be detected using a similar graphing mechanism. Also note that although a follower relationship is used here for Ponzi scheme detection, other relationships may exist and used for detection and the graph/subgraphs 400/450 presented herein is for exemplary purposes as other graphs and/or subgraphs may be possible.

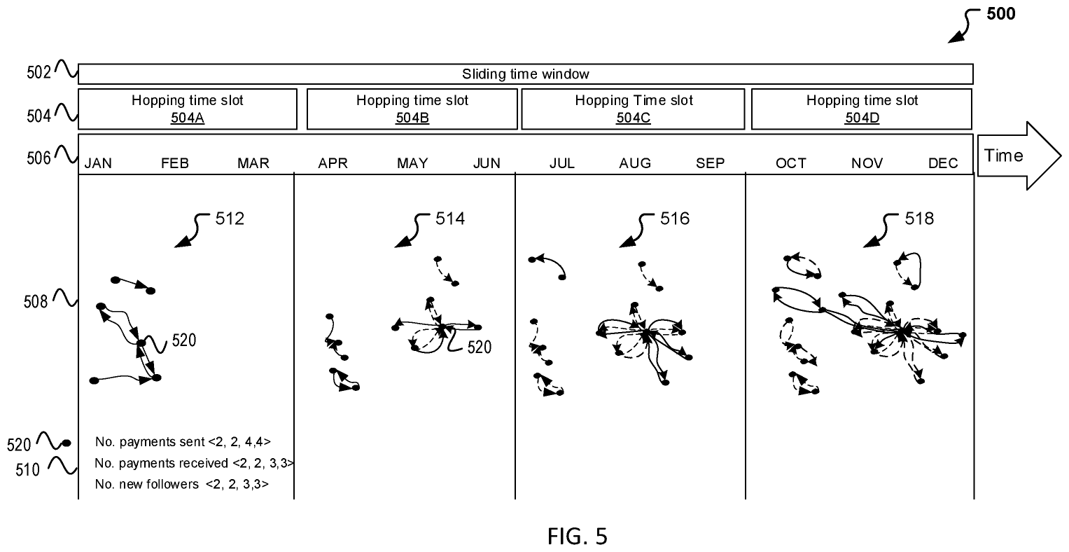

Next, as indicated above, a timing window may be used to identify those accounts or payment relationships from which the subgraphs are generated. The timing window enables the identification and limitation of those transactions occurring over the time span provided. Therefore, in some embodiments, a sliding time window may be used for varying time intervals. To illustrate how a sliding time window may be used for the generation of time-evolving payment graphs, consider FIG. 5.

At FIG. 5, exemplary time-evolving graph 500 for Ponzi scheme detection. The time-evolving graph 500 as illustrated includes the sliding window 502 as indicated above and used for determining those subsets of payments that happen within a defined time period for which those payments or transactions may be considered for further analysis such as but not limited to Ponzi scheme detection. In this time-evolving graph 500, a one-year time period 506 is considered. Once the time period for use with the sliding window 502, the time period 506 is further modularized into smaller time segments or hopping time slots 504. The hopping time slots 504 can be adjacent, even-sized, non-overlapping hopping windows. The hopping time slots 504 can be used to further define a subset of payments which may occur within the sliding time window 502 and fall within the designated hopping time slot 506 and for which a graph-based computation will be performed. Therefore, considering the time period 504 used, each hopping time slot is configured for approximately 3 months worth of transactions and for whose payment patterns will be considered and analyzed. Turning to the first-time hopping slot 504A (e.g., from January-March), a simple graph 512 is illustrated with those transactions occurring between a few selected accounts.

Recall that as previously indicated, the vertexes of the graph may be used to refer to accounts whereas the edges represent a payment between the accounts. Thus, during the first hoping time slot, it could be generally stated that for the time period and/or accounts under consideration, approximately six accounts interacted with three of those accounts involved in a transaction associated with a Ponzi scheme. Next, turning to the next and adjacent hopping time slot 506B, a new set of transactions may have occurred as indicated here on the graph 514 by the solid lines.

Graphs then become time-evolving and at graph 516, hopping time slot 504C, of the year-long time period 506, the transactions occurring between July-September are now considered. Again, because the time-evolving graph 500 is indeed accounting for prior and new account transactions, dashed lines are used for previous transactions while new ones are denoted by the solid lines. At graph 518, the sliding time window 502 has been fully accounted for and the graph 518 now represents a time-evolving graph consisting of those transactions between two or more accounts.

Note, in some instances, the hopping time slots may be uneven, dynamic, non-adjacent, tunable, etc. based on the scheme and analysis to be determined. In addition, the time period 506 may be longer or shorter than that illustrated as well as the sliding time window 502. For example, the time under consideration may be during a holiday season, in the summer time, or dynamic based on transaction loads. Also note that a larger size sliding window may represent a longer period of payments, while a smaller sliding window may indicate smaller sized hopping time slots will be considered in the analysis.

Now, in consideration of the time-evolving graph, each graph 508 may be considered individually to obtain the desired metrics. Intuitively, those accounts which illustrate a quick expansion with bi-directional activity between two or more accounts may designate the potential for a possible Ponzi scheme. To determine if indeed there exist the potential for a Ponzi scheme, metrics may be computed for each graph 508 in order to obtain an aggregate network-based metrics whose attributes provide an indication of the existence of the Ponzi scheme.

In one embodiment, for each account or vertex, different kinds of time-based graph metric vectors may be computed. For example, for an N-dimensional vector

<x₁,x₂, . . . xₙ>

may be defined where N is the number of hopping time slots 506 within the sliding time window 502. The value (e.g., xᵢ) within the N-dimensional metrics can then be one of the aggregate metrics that could be calculated based on the account (vertex) and payment (edge) that falls in the i^{th} hopping time slot. Then, using the values computed or determined on the vector, various metrics may be computed.

Turning back for FIG. 5, an exemplary metric computation is illustrated for determining if a scheme is present. To illustrate, first consider a vertex 520, which has been highlighted in gray for each hopping time slot 504. At hopping time slot 504A, it could be determined that two payments have been sent (information is leaving or outgoing edge), two payments are received (incoming edges), and two new followers are identified. Similarly, shifting to the adjacent time slot 504B, with the prior transactions now distinguished by dashes, it can be determined that again at vertex 520, two more payments are sent, two are receive and two new followers are present. This process can then be continued to obtain the vector metrics associated with the time-evolving graph 500 as represented by metric vectors 510.

Note that other types of metrics may be determined and identified in a similar manner. For example, instead consider a transactional metrics and/or network metrics. For transactional metrics, a net transaction amount and total transactional count could also be determined. Transactional metrics could be metrics that are determined on a hopping time slot, on an account, and related to outgoing edges to determine number of payments sent or alternatively payments received from incoming edges. This is similar to the metrics 510 considered above and described in conjunction with FIG. 5. Aggregate metrics may also be determined. For example, using the transactional metrics calculated and aggregated over numerous hopping time slots, an accounts payment volume can be determined. In one embodiment, growth rate could be computed and used for tracing a trend of growth of an accounts' payment volume. The growth rate may be computed as

$$growth rate = \frac{{x}_{n} - {x}_{n - 1}}{{x}_{n - 1}}$$

where the growth rate is a function of the N-dimensional vector previously determined.

As indicated, other metrics are also possible including network metrics or follower metrics which can help highlight a property associated with a Ponzi scheme. Generally, a Ponzi scheme account needs to attract new investors in order to use their investment funds as returns to existing members or investors of the organization. Hence, the number of new followers and how fast an account expands its followers are important properties can be used to flag the existence of a possible Ponzi scheme. Therefore, network metric vectors may be determined and used to determine how fast an account is expanding its payment network. In other words, how many and how quickly is an account gaining followers. To detect the number of new followers for one account, the number of new one-hop neighbors in each hopping time slot may be determined (see FIG. 5, vector metrics 510). As another example, an abnormality may be detected based on a normal trend anticipated or seen from followers.

Like transactional metrics, network metrics may also be used to obtain aggregate metrics. For example, aggregate metrics of followers can be determined and used to show how different a potential Ponzi account is from other followers. Thus, if one Ponzi account's net transaction amount grows quickly, while the follower's net transaction amount decreases, an indication of a possible risk may be risen here. With additional account information available, additional metrics may also be determined and used for risk detection. User IP login, location, region, etc., may also be available and used for computing additional metrics such as a follower's geographical location distribution. In some Ponzi schemes, accounts exhibit a large number broad geographical transactions, thus is a follower's geographical location distribution is known, a Ponzi scheme may be detected. Then, expanding this a step further, advanced algorithms such as but not limited to the label propagation algorithm may be applied for detecting communities of payment networks.

Once all metrics are known, Ponzi scheme detection or other high-risk account detection may be accomplished using a set of filters which may be put in place that will distinguish the accounts that should be further scrutinized or investigated. For exemplary purposes, some filters that may be used for a Ponzi scheme central account detection include: 1) contains many bi-directional transactions with many followers, 2) net transaction amount and total transaction count grows quickly, 3) has large net transaction amount and transaction count and those amounts are much greater than its 1-hop followers, etc.

Note that further to the listed filters above, other filters and criteria may be added for Ponzi scheme or another risky scheme detection. Further, specific values regarding how much a specific metric should be may be set or dynamically defined. For example, a 12-month time period may be considered, a growth rate >1.1 may be considered, top 1% network size considered, etc. Additional filters may be set and used to fine to the detection of a fraudulent scheme, master account in a Ponzi scheme, etc.

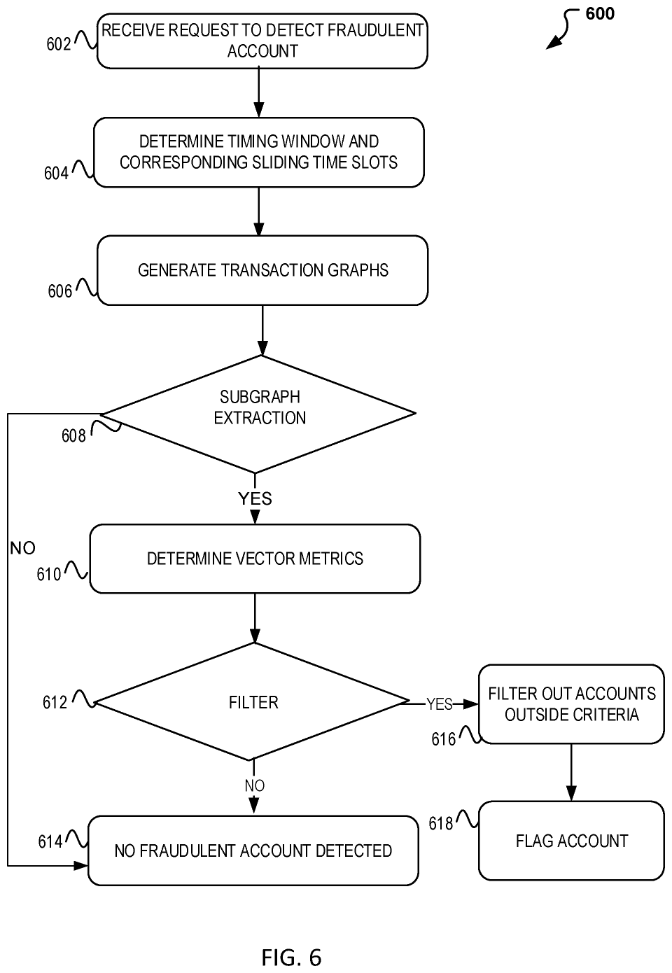

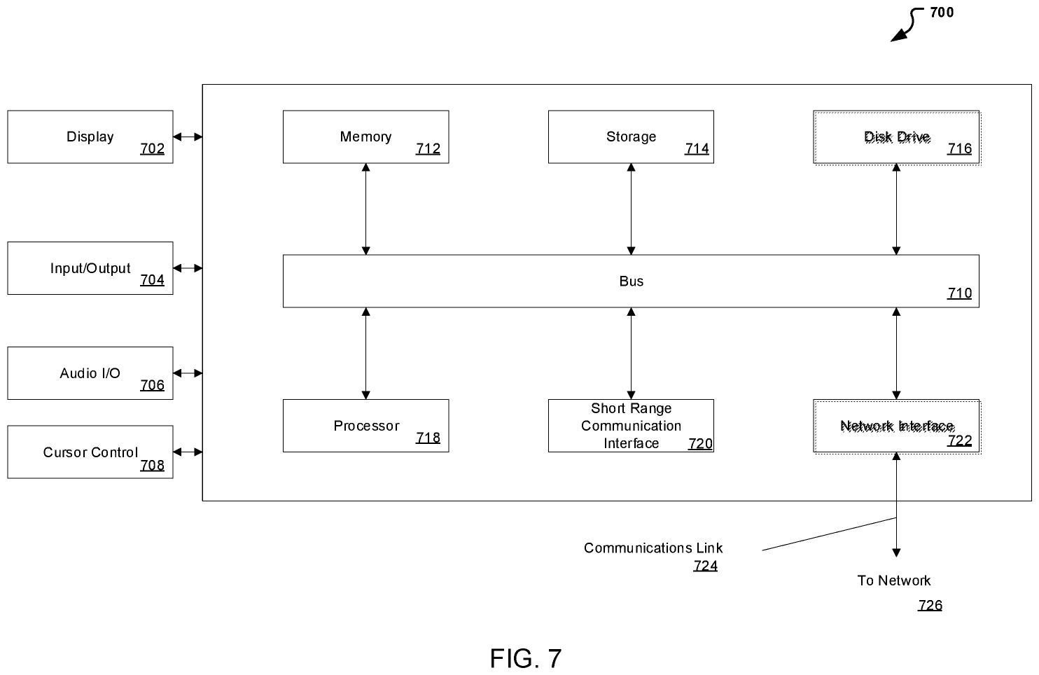

To illustrate how the time-evolving graph may be used for Ponzi scheme detection, FIG. 6 is introduced which illustrates example process 600 that may be implemented on a system, such as system 700 in FIG. 7 and/or architecture 200 in FIG. 2. FIG. 6 illustrates a flow diagram illustrating how to generate and determine if a Ponzi scheme exists as applicable between two or more users transacting. According to some embodiments, process 600 may include one or more of operations 602-618, which may be implemented, at least in part, in the form of executable code stored on a non-transitory, tangible, machine readable media that, when run on one or more hardware processors, may cause a system to perform one or more of the operations 602-618.

Process 600 may begin with operation 602, where a request is received to detect if a fraudulent account exists in a plurality of accounts. The request may be received and initiated by a machine or device working through a platform and dashboard where details regarding the time-period, metrics desired and filters to apply for detection. Additionally, other parameters may be set including the type of detection scheme desired, the user of interest, geo location, etc. As previously indicated, account information, transactional data, users, payment information, etc. may be collected and available for retrieval from data storage 208 as illustrated in conjunction with FIG. 2. Therefore, at operation 602, upon receipt of a request, relevant information to the request may be obtain from a server, cloud, machine, device, etc. which is storing the data. Additionally, or alternatively, to detect followers, associated accounts, transactions, etc., data may also be pulled from external web sources, social media, contact information, user profiles, and the like.

Once the request and data is retrieved, process 600 continues to operation 604 where the time-evolving graph process is initiated. To generate the time-evolving graph, a timing window and corresponding hopping time slots. As previously indicated, a timing window can be a time period under consideration that may be used to identify those accounts or payment relationships that are targeted for investigation and Ponzi scheme detection. The hopping time slots are therefore the smaller windows created from which the subgraphs are generated and from which metrics may be obtained. In particular, as previously indicated, the hopping time slots can be adjacent, even-sized, non-overlapping hopping windows. The hopping time slots can be used to further define a subset of payments which may occur within the sliding time window and fall within the designated hopping time slot and for which a graph-based computation will be performed.

As the designated time-period and intervals (e.g., through timing window and hopping time slots) are designated, the process 600 continues to operation 606 where graphs illustrating the transactions occurring between two or more accounts (designated, random, or generally accounts that transact during the sliding time window). The graph can be generated by assigning account names, users, businesses, entities, etc. with a vertex and using an edge to show the association, much like that described in greater detail above and in conjunction with FIGS. 3A-3C. As the overall graph is created, a decision is then made at operation 608 where it is determined whether a subgraph should be extracted from the graph. Here again, much like the description of FIG. 4, the objective is to identify those flow patterns commonly seen in fraudulent schemes such as a Ponzi scheme. Therefore, patterns that include a bi-directional transaction between two accounts, or accounts that have a large number of followers, etc. may be highlighted and used in determining the corresponding vector metrics as indicated at operation 610. Note that the process of graph construction and subgraph extraction is then repeated over a hopping time slot and from which time-based metrics can be computed.

Identifying vector metrics at operation 610 can include a series of analysis wherein transactional metrics, network metrics, and aggregate metrics may be determined based on flow patterns and communications between accounts. As described above, vector metrics can include metrics that are determined on a hopping time slot, on an account, and related to outgoing edges to determine number of payments sent or alternatively payments received from incoming edges. Additionally, vector metrics can include vectors that may be used to determine how fast an account is expanding its payment network. In other words, how many and how quickly the account is gaining followers. Aggregate metrics can include growth rates and can be indicators of centralized accounts based in part on how fast an account is expanding its payment network. In other words, how many and how quickly is an account gaining followers. To detect the number of new followers for one account, the number of new one-hop neighbors in each hopping time slot may be determined.

Next, at operation 612, once vectors have been determined a decision as to whether filtering should be added is considered. For example, if the purpose of the analysis is to determine whether the account under consideration is a centralized account, then some filters may be added and used to detect whether some pre-defined parameters are met. Exemplary parameters can include whether the account contains many bi-directional transactions with many followers, net transaction amount and total transaction count grows quickly, and growth rate >1.1. Other filter parameters and threshold values may be set, tuned, and may vary depending on the type of scheme and detection being considered. If filtering is indeed used, then operation 612 continues to operation 616 where those accounts and transactions that do not fit the criteria are removed from consideration. Then, given the remaining information, a decision may be made and account flagged if the scheme is determined to be a centralized account. Alternatively, if no filter is needed then the process 600 may continue to operation 614 where if no accounts remain or are of suspicion, then at operation 612 no fraudulent account is detected.

Note that in some instances, even without filtering, the account may be flagged as suspicious if the metric determined at operation 610 are sufficient to detect one. Additionally, after filtering out criteria 616, there may be some instances where no accounts are flagged and thus operation 616 instead terminates at operation 614. Also note that the order and number of operations listed are only for exemplary purposes and more or less operations may be possible. The order of the operations may also be updated and combined. For example, determining the sliding time window may be a distinct operation from determining the corresponding sliding time slots. As another example, there may be no need to determine if a subgraph is needed and instead a subgraph extraction occurs as a sequential operation as oppose to a decision. Other similar examples and arrangement of operations may be contemplated.

FIG. 7 illustrates an example computer system 700 in block diagram format suitable for implementing on one or more devices of the system in FIGS. 1-6. In various implementations, a device that includes computer system 700 may comprise a personal computing device (e.g., a smart or mobile device, a computing tablet, a personal computer, laptop, wearable device, PDA, etc.) that is capable of communicating with a network 726. A service provider and/or a content provider may utilize a network computing device (e.g., a network server) capable of communicating with the network. It should be appreciated that each of the devices utilized by users, service providers, and content providers may be implemented as computer system 700 in a manner as follows.

Additionally, as more and more devices become communication capable, such as new smart devices using wireless communication to report, track, message, relay information and so forth, these devices may be part of computer system 700. For example, windows, walls, and other objects may double as touch screen devices for users to interact with. Such devices may be incorporated with the systems discussed herein.

Computer system 700 may include a bus 710 or other communication mechanisms for communicating information data, signals, and information between various components of computer system 700. Components include an input/output (I/O) component 704 that processes a user action, such as selecting keys from a keypad/keyboard, selecting one or more buttons, links, actuatable elements, etc., and sending a corresponding signal to bus 710. I/O component 704 may also include an output component, such as a display 702 and a cursor control 708 (such as a keyboard, keypad, mouse, touchscreen, etc.). In some examples, I/O component 704 other devices, such as another user device, a merchant server, an email server, application service provider, web server, a payment provider server, and/or other servers via a network. In various embodiments, such as for many cellular telephone and other mobile device embodiments, this transmission may be wireless, although other transmission mediums and methods may also be suitable. A processor 718, which may be a micro-controller, digital signal processor (DSP), or other processing component, that processes these various signals, such as for display on computer system 700 or transmission to other devices over a network 726 via a communication link 724. Again, communication link 724 may be a wireless communication in some embodiments. Processor 718 may also control transmission of information, such as cookies, IP addresses, images, and/or the like to other devices.

Components of computer system 700 also include a system memory component 714 (e.g., RAM), a static storage component 714 (e.g., ROM), and/or a disk drive 716. Computer system 700 performs specific operations by processor 718 and other components by executing one or more sequences of instructions contained in system memory component 712 (e.g., for engagement level determination). Logic may be encoded in a computer readable medium, which may refer to any medium that participates in providing instructions to processor 618 for execution. Such a medium may take many forms, including but not limited to, non-volatile media, volatile media, and/or transmission media. In various implementations, non-volatile media includes optical or magnetic disks, volatile media includes dynamic memory such as system memory component 712, and transmission media includes coaxial cables, copper wire, and fiber optics, including wires that comprise bus 710. In one embodiment, the logic is encoded in a non-transitory machine-readable medium. In one example, transmission media may take the form of acoustic or light waves, such as those generated during radio wave, optical, and infrared data communications.

Some common forms of computer readable media include, for example, hard disk, magnetic tape, any other magnetic medium, CD-ROM, any other optical medium, RAM, PROM, EPROM, FLASH-EPROM, any other memory chip or cartridge, or any other medium from which a computer is adapted to read.

Components of computer system 700 may also include a short-range communications interface 720. Short range communications interface 720, in various embodiments, may include transceiver circuitry, an antenna, and/or waveguide. Short range communications interface 720 may use one or more short-range wireless communication technologies, protocols, and/or standards (e.g., Wi-Fi, Bluetooth®, Bluetooth Low Energy (BLE), infrared, NFC, etc.).

Short range communications interface 720, in various embodiments, may be configured to detect other devices (e.g., user device, merchant device, server, laptop, smart device, etc.) with short range communications technology near computer system 700. Short range communications interface 720 may create a communication area for detecting other devices with short range communication capabilities. When other devices with short range communications capabilities are placed in the communication area of short range communications interface 720, short range communications interface 720 may detect the other devices and exchange data with the other devices. Short range communications interface 720 may receive identifier data packets from the other devices when in sufficiently close proximity. The identifier data packets may include one or more identifiers, which may be operating system registry entries, cookies associated with an application, identifiers associated with hardware of the other device, and/or various other appropriate identifiers.

In some embodiments, short range communications interface 720 may identify a local area network using a short-range communications protocol, such as Wi-Fi, and join the local area network. In some examples, computer system 700 may discover and/or communicate with other devices that are a part of the local area network using short range communications interface 720. In some embodiments, short range communications interface 720 may further exchange data and information with the other devices that are communicatively coupled with short range communications interface 720.

In various embodiments of the present disclosure, execution of instruction sequences to practice the present disclosure may be performed by computer system 700. In various other embodiments of the present disclosure, a plurality of computer systems 700 coupled by communication link 724 to the network (e.g., such as a LAN, WLAN, PTSN, and/or various other wired or wireless networks, including telecommunications, mobile, and cellular phone networks) may perform instruction sequences to practice the present disclosure in coordination with one another. Modules described herein may be embodied in one or more computer readable media or be in communication with one or more processors to execute or process the techniques and algorithms described herein.

A computer system may transmit and receive messages, data, information and instructions, including one or more programs (i.e., application code) through a communication link 724 and a communication interface. Received program code may be executed by a processor as received and/or stored in a disk drive component or some other non-volatile storage component for execution.

Where applicable, various embodiments provided by the present disclosure may be implemented using hardware, software, or combinations of hardware and software. Also, where applicable, the various hardware components and/or software components set forth herein may be combined into composite components comprising software, hardware, and/or both without departing from the spirit of the present disclosure. Where applicable, the various hardware components and/or software components set forth herein may be separated into sub-components comprising software, hardware, or both without departing from the scope of the present disclosure. In addition, where applicable, it is contemplated that software components may be implemented as hardware components and vice-versa.

Software, in accordance with the present disclosure, such as program code and/or data, may be stored on one or more computer readable media. It is also contemplated that software identified herein may be implemented using one or more computers and/or computer systems, networked and/or otherwise. Where applicable, the ordering of various steps described herein may be changed, combined into composite steps, and/or separated into sub-steps to provide features described herein.

The foregoing disclosure is not intended to limit the present disclosure to the precise forms or particular fields of use disclosed. As such, it is contemplated that various alternate embodiments and/or modifications to the present disclosure, whether explicitly described or implied herein, are possible in light of the disclosure. For example, the above embodiments have focused on the user and user device, however, a customer, a merchant, a service or payment provider may otherwise presented with tailored information. Thus, “user” as used herein can also include charities, individuals, and any other entity or person receiving information. Having thus described embodiments of the present disclosure, persons of ordinary skill in the art will recognize that changes may be made in form and detail without departing from the scope of the present disclosure. Thus, the present disclosure is limited only by the claims.

What is claimed is:

1. A system comprising:
a non-transitory memory storing instructions; and
a processor configured to execute instructions to cause the system to:
in response to receiving a request to detect fraudulent account activity, establish a timing window for a desired time-period of interest;
generate a set of time-evolving graphs corresponding to the established timing window;
determine vector metrics associated with the set of time-evolving graphs; and
identify a fraudulent account based on the vector metrics determined.

2. The system of claim 1, executing instructions further causes the system to:
determine a number of hopping time slots to allocate within the established timing window and generate adjacent hopping time slots according to the number determined; and
allocate a time-evolving graph from the set of time-evolving graphs to each of the hopping time slots.

3. The system of claim 2, executing the instructions further causes the system to:
extract a subgraph from each of the timing-evolving graphs; and
calculate metrics for each subgraph associated with the time-evolving graph.

4. The system of claim 3, wherein the subgraph is extracted based on pattern flows customary of a fraudulent account.

5. The system of claim 4, wherein the pattern flows include a bi-directional communication between two accounts.

6. The system of claim 3, wherein the vector metrics include the metrics for each subgraph and used to determine growth rate.

7. The system of claim 1, executing instructions further causes the system to:
filter out data from the of time-evolving graphs based in part on the vector metrics determined and identify the fraudulent account based on the filtered data.

8. The system of claim 1, wherein fraudulent account activity includes activity associated with a Ponzi scheme.

9. A method comprising:
in response to receiving a request to detect fraudulent account activity, establishing a timing window for a desired time-period of interest;
generating a set of time-evolving graphs corresponding to the established timing window;
determining vector metrics associated with the set of time-evolving graphs; and
identifying a fraudulent account based on the vector metrics determined.

10. The method of claim 9, further comprising:
determining a number of hopping time slots to allocate within the established timing window and generate adjacent hopping time slots according to the number determined; and
allocating a time-evolving graph from the set of time-evolving graphs to each of the hopping time slots.

11. The method of claim 10, further comprising:
extracting a subgraph from each of the timing-evolving graphs; and
calculating metrics for each subgraph associated with the time-evolving graph.

12. The method of claim 11, wherein the subgraph is extracted based on pattern flows customary of a fraudulent account.

13. The method of claim 12, wherein the pattern flows include a bi-directional communication between two accounts.

14. The method of claim 9, wherein the vector metrics include the metrics for each subgraph and used to determine growth rate.

15. The method of claim 9, further comprising:
filter out data from the of time-evolving graphs based in part on the vector metrics determined and identify the fraudulent account based on the filtered data.

16. The method of claim 9, wherein fraudulent account activity includes activity associated with a Ponzi scheme.

17. A non-transitory machine-readable medium having stored thereon machine readable instructions executable to cause a machine to perform operations comprising:
in response to receiving a request to detect fraudulent account activity, establishing a timing window for a desired time-period of interest;
generating a set of time-evolving graphs corresponding to the established timing window;
determining vector metrics associated with the set of time-evolving graphs; and
identifying a fraudulent account based on the vector metrics determined.

18. The non-transitory medium of claim 17, further comprising:
determining a number of hopping time slots to allocate within the established timing window and generate adjacent hopping time slots according to the number determined; and
allocating a time-evolving graph from the set of time-evolving graphs to each of the hopping time slots.

19. The non-transitory medium of claim 18, further comprising:
extracting a subgraph from each of the timing-evolving graphs; and
calculating metrics for each subgraph associated with the time-evolving graph.

20. The non-transitory medium of claim 19, wherein the subgraph is extracted based on pattern flows customary of a fraudulent account.
